(19) United States
(12) Patent Application Publication
(10) Pub. No.: US 2005/0062669 A1
(43) Pub. Date: Mar. 24, 2005

(54) Low cost antenna devices comprising conductive loaded resin-based materials with conductive threading or stitching

(75) Inventor: Thomas Aisenbrey, Littleton, CO (US)

Correspondence Address: STEPHEN B. ACKERMAN, 28 DAVIS AVENUE, POUGHKEEPSIE, NY, 12603, US

(73) Assignee: Integral Technologies, Inc.

(21) Appl. No.: 10/963,294

(22) Filed: Oct. 12, 2004

Related U.S. Application Data
(63) Continuation-in-part of application No. 10/309,429, filed on Dec. 4, 2002.
Application No. 10/309,429 is a continuation-in-part of application No. 10/075,778, filed on Feb. 14, 2002, now Pat. No. 6,741,221.
(60) Provisional application No. 60/509,791, filed on Oct. 9, 2003.
(60) Provisional application No. 60/519,020, filed on Nov. 10, 2003.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. H01Q 9/28; H01Q 1/40

(52) U.S. Cl. 343/795; 343/873

(57) ABSTRACT

Antennas are formed of a conductive loaded resin-based material with conductive threading or stitching. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are formed from non-metals, such as carbon, graphite, that may also be metallic plated, or the like, or from metals such as stainless steel, nickel, copper, silver, that may also be metallic plated, or the like, or from a combination of non-metal, plated, or in combination with, metal powders. The micron conductor fibers preferably are of nickel plated carbon fiber, stainless steel fiber, copper fiber, silver fiber, or the like.

This Patent Application claims priority to U.S. Provisional Patent Application Ser. No. 60/509,791, filed on Oct. 9, 2003, and to U.S. Provisional Patent Application Ser. No. 60/519,020, filed on Nov. 10, 2003, which are herein incorporated by reference in their entirety.

This patent application is a Continuation-in-Part of INT01-002CIP, filed as U.S. patent application Ser. No. 10/309,429, filed on Dec. 4, 2002, also incorporated by reference in its entirety, which is a Continuation-in-Part application of docket number INT01-002, filed as U.S. patent application Ser. No. 10/075,778, filed on Feb. 14, 2002, which claimed priority to US Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001.

### BACKGROUND OF THE INVENTION

(1) Field of the Invention

This invention relates to antenna devices and, more particularly, to antenna devices molded of conductive loaded resin-based materials and utilizing conductive threading or stitching. The conductive loaded resin-based material comprises micron conductive powders, micron conductive fibers, or a combination thereof, homogenized within a base resin when molded. This manufacturing process yields a conductive part or material usable within the EMF or electronic spectrum(s).

(2) Description of the Prior Art

Antenna devices are generally classified as any structures capable of receiving and/or transmitting electromagnetic energy. Antennas typically comprise conductive materials capable of converting electromagnetic field energy into electrical currents and visa versa. Of particular importance in the design of useful antenna devices are the concepts of resonance frequency and bandwidth and antenna gain or attenuation. Each antenna structure exhibits characteristic responses to different frequencies of electromagnetic energy. The frequency at which the antenna device exhibits highest gain, or lowest attenuation, is the resonance frequency for the antenna. The range of frequencies around the resonance frequency for which the antenna device exhibits a most useful response, typically defined at −3 dB of resonant gain or the like, is called the frequency bandwidth of the antenna. These response features depend greatly on the antenna material, shape, size, and signal coupling means. It is an important object of the present invention to provide an improved antenna device that incorporates a unique antenna material, a unique signal coupling and resonance tuning approach, and unique fabrication methods.

Several prior art inventions relate to antenna elements and tuning methods. U.S. patent Publication Us 2003/0030591 A1 to Gipson et al teaches a sleeved dipole antenna with a method to reduce noise utilizing a ferrite sleeve disposed radially around the coaxial feed line. This invention also teaches that the conductive radiators are constructed of aluminum, steel, brass, stainless steel, titanium or copper. U.S. Pat. No. 5,990,841 to Sakamoto et al teaches a wide-band antenna and tuning method utilizing a rod, a movable coil connected to the rod, and a cylindrical conductive holding section. U.S. patent Publication US 2001/0050645 A1 to Boyle teaches a portable device antenna that is fabricated inside or outside a garment that is worn by the user. This invention also teaches the use of a conductive thread or threads for use as the radiating element of the antenna. U.S. patent Publication US 2002/0089458 A1 to Allen et al teaches a garment antenna that utilizes copper, silver or nickel that is electroless plated onto rip-stop nylon as the conductive element layers. This invention also teaches the use of conductive thread for the connections between the conductive elements. U.S. patent Publication US 2003/0160732 A1 to Van Heerden et al teaches a fabric antenna for use with RFID tags that utilizes either conductive threads or a woven nylon plated with a layer of copper, silver, or nickel as the conductive element.

### SUMMARY OF THE INVENTION

A principal object of the present invention is to provide an effective antenna device.

A further object of the present invention is to provide a method to form an antenna device.

A further object of the present invention is to provide an antenna molded of conductive loaded resin-based materials.

A yet further object of the present invention is to provide an antenna molded of conductive loaded resin-based materials and, further, formed of conductive wires, or threads, embedded into the antenna.

A yet further object of the present invention is to provide an antenna molded of conductive loaded resin-based material and conductive wires, or threads, where the wires, or threads, provide a means of tuning the antenna.

A yet further object of the present invention is to provide an antenna molded of conductive loaded resin-based material and conductive wires, or threads, where the wires, or threads, provide a means of coupling a signal onto or off from the antenna.

A yet further object of the present invention is to provide methods to fabricate an antenna from a conductive loaded resin-based material and conductive wires, or threads.

A yet further object of the present invention is to provide a method to fabricate an antenna from a conductive loaded resin-based material where the material is in the form of a fabric.

In accordance with the objects of this invention, an antenna device is achieved. The antenna device comprises an element of conductive loaded, resin-based material comprising conductive materials in a base resin host. A conductive wire is embedded into the conductive loaded, resin-based material.

Also in accordance with the objects of this invention, a method to form an antenna device is achieved. The method comprises providing a conductive loaded, resin-based material comprising conductive materials in a resin-based host. The conductive loaded, resin-based material is molded into the antenna device. A conductive wire is stitched into the antenna device.

### BRIEF DESCRIPTION OF THE DRAWINGS

In the accompanying drawings forming a material part of this description, there is shown:

FIGS. 1a and 1b illustrate a first preferred embodiment of the present invention showing a dipole antenna comprising conductive loaded resin-based material and conductive wires, or threads, according to the present invention. Side and cross sectional views are shown. The transmit/receive antenna and counterpoise each comprise conductive loaded resin-based panels with signals coupled using insulated conductive wire that is stitched into the panels.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold an antenna of a conductive loaded resin-based material.

FIG. 7 illustrates, in cross sectional view, a second preferred embodiment of the present invention where the conductive wire is not insulated.

FIG. 8 illustrates a third preferred embodiment of the present invention showing a dipole antenna having a butterfly shape where the transmit/receive antenna and the counterpoise comprise the conductive loaded resin-based material. The transmit/receive signal and counterpoise signal are coupled using conductive wire that is stitched into the antenna wings.

FIG. 9 illustrates a fourth preferred embodiment of the present invention showing a monopole antenna comprising the conductive loaded resin-based material of the present invention and having a loop of conductive wire stitched into the antenna.

FIG. 10 illustrates a fifth preferred embodiment of the present invention showing a method to form an antenna device. The antenna device is molded, then perforated, then stitched.

FIG. 11 illustrates a sixth preferred embodiment of the present invention showing a method to form an antenna device. The antenna device is molded with perforations and then stitched.

FIG. 12 illustrates a seventh preferred embodiment of the present invention showing a method to form an antenna device. The antenna device is molded and then perforated while being stitched.

FIG. 13 illustrates an eighth preferred embodiment of the present invention showing an antenna device comprising conductive loaded resin-based material and conductive wire stitching. A conformal layer is formed over the device for protection, insulation, and/or visual purposes.

FIGS. 14a and 14b illustrate a ninth preferred embodiment of the present invention showing an antenna device comprising conductive loaded resin-based material and a conductive wire. The conductive wire is molded into the antenna device. Top and cross sectional views are shown.

### DESCRIPTION OF THE PREFERRED EMBODIMENTS

This invention relates to antennas molded of conductive loaded resin-based materials comprising micron conductive powders, micron conductive fibers, or a combination thereof, homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of antennas fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the antenna devices are homogenized together using molding techniques and or methods such as injection molding, over-molding, insert molding, thermo-set, protrusion, extrusion or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

The use of conductive loaded resin-based materials in the fabrication of antennas significantly lowers the cost of materials and the design and manufacturing processes used to hold ease of close tolerances, by forming these materials into desired shapes and sizes. The antenna devices can be manufactured into infinite shapes and sizes using conventional forming methods such as injection molding, over-molding, or extrusion or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are homogenized together within the base resin, during the molding process, yielding an easy to produce low cost, electrically conductive, close tolerance manufactured part or circuit. The micron conductive powders can be of carbons, graphites, amines or the like, and/or of metal powders such as nickel, copper, silver, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The micron conductive fibers can be nickel plated carbon fiber, stainless steel fiber, copper fiber, silver fiber, or the like, or combinations thereof. The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion to create desired shapes and sizes. The molded conductive loaded resin-based materials can also be stamped, cut or milled as desired to form create the desired shape form factor(s) of the antenna devices. The doping composition and directionality associated with the micron conductors within the loaded base resins can affect the electrical and structural characteristics of the antenna devices and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming antenna devices that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in antenna applications as described herein.

The homogeneous mixing of micron conductive fiber and/or micron conductive powder and base resin described in the present invention may also be described as doping. That is, the homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the homogeneous mixing of micron conductive fiber and/or micron conductive powder into a base resin.

As an additional and important feature of the present invention, the molded conductor loaded resin-based material exhibits excellent thermal dissipation characteristics.

Therefore, antenna devices manufactured from the molded conductor loaded resin-based material can provide added thermal dissipation capabilities to the application. For example, heat can be dissipated from electrical devices physically and/or electrically connected to an antenna of the present invention.

If needed, a metal layer may be formed onto the conductive loaded resin-based antenna material. The metal layer may be formed, for example, by a deposition process or by a metallic painting process. A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

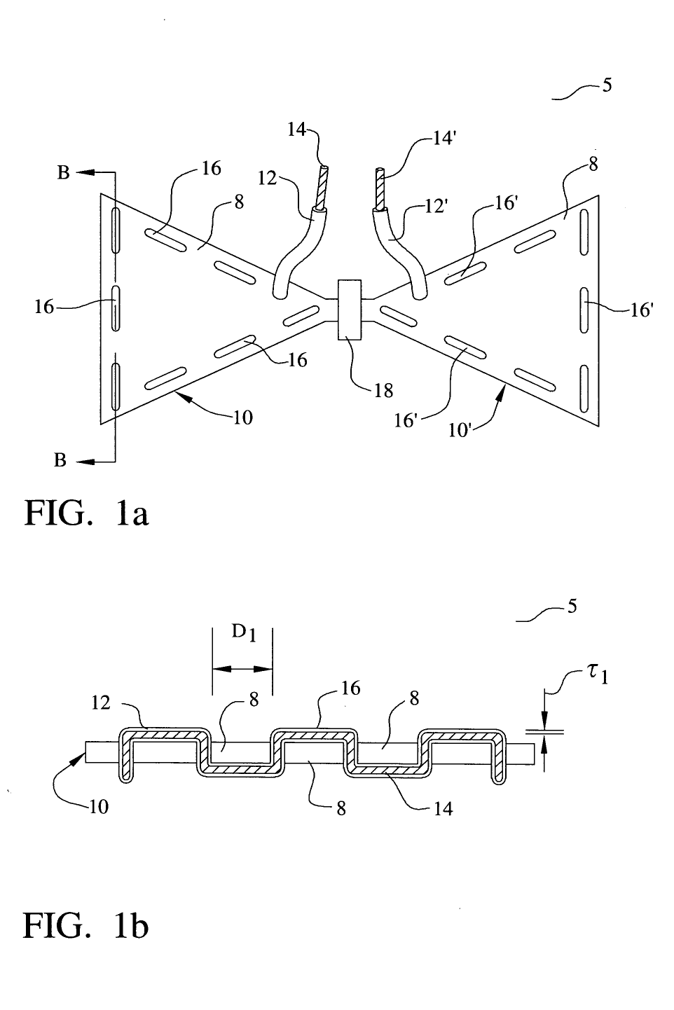

Referring now to FIGS. 1a and 1b, a first preferred embodiment of the present invention is illustrated. Several important features of the present invention are shown and discussed below. Referring now to FIG. 1a, an antenna device 5 is shown. The antenna device 5 comprises conductive loaded resin-based material according to the present invention. In particular, a dipole antenna 5 with two panels 10 and 10′ is shown. Each panel 10 and 10′ is formed of the conductive loaded resin-based material of the present invention. The left panel 10 is the transmit/receive antenna, or signal antenna, while the right panel 10′ is the counterpoise. In the embodiment, the signal element 10 and the counterpoise element 10′ are held in place by an insulating element 18.

As an important feature of the present invention, a conductive wire, thread, or stitching 16 and 16′ is laced, stitched, woven, or otherwise embedded, into each panel 10 and 10′. In the particular embodiment shown, a signal wire 16 comprising a core conductor 14 and an insulating jacket 12 is laced, or stitched, into the conductive loaded resin-based material 8 of the signal antenna 10. Similarly, a grounding, or counterpoise, wire 16′ comprising a core conductor 14′ and an insulating jacket 12′ is laced, or stitched, into the conductive loaded resin-based material 8 of the counterpoise element 10′.

Referring now to FIG. 1b, the antenna device 5 is shown in a cross section of the signal element 10. The conductive wire 16 is laced through holes in the conductive loaded resin-based material 8. The conductive wire 16 performs several key functions in the unique device 5. First, the conductive wire 16 couples the signal onto (in the case of transmission) or off from (in the case of reception) the conductive loaded resin-based antenna element 10. In the preferred embodiment shown, the conductive wire 16 bears an insulating jacket 12 around the conductive core 14. Therefore, the signal-to-antenna coupling is capacitive, or indirect. In particular, the wire core 14 and the conductive loaded resin-based material 8 are separated by the insulator 12 such that a parasitic capacitance exists between the wire core 14 and the micron conductive network of the antenna material 8.

The capacitive coupling between the wire core 14 and the conductive loaded resin-based material creates several unique features to the present invention. First, signal energy transfer into or out from the conductive loaded resin-based antenna material 8 is distributed gradually across the antenna element 10. An excellent distributed connection is formed between the signal wire 16 and the antenna material 8. Second, the conductive stitching 16 performs as an electrical collection point for the micron network of conductive fibers and/or powders within the resin-based material. In this respect, and using the analogy of the human vascular system, the micron conductive network of the conductive loaded resin-based material 8 functions like a capillary system while the conductive wire stitching 16 functions like a vein or artery system connected to the capillary system.

Third, the conductive stitching 16 provides a very useful method for tuning the antenna 5. The parasitic capacitive coupling (Ccoupling) between the signal wire core 14 and the antenna material 8 provides a complex variable that can used to fine tune the frequency response of the antenna device 5. Generally, the frequency response of the antenna device 5 is established, to first order, by the perimeter dimensions of the antenna panels 10 and 10′. In particular, the antenna elements 10 and 10′ are designed to have perimeter dimensions corresponding to fractional multiples of quarter wavelengths of the desired resonance frequency. As such, the gross, or rough, tuning of the antenna elements 10 and 10′ is set by the size and shape of the conductive loaded resin-based material 8. These dimensions, in turn, are preferably established by molding the conductive loaded resin-based material.

Further fine tuning of the antenna 5 resonance properties, such as resonance frequency, the resonance bandwidth, the capacitive balance, the inductive balance, the Q value, and the like, is preferably accomplished by the conductive stitching 16. In one embodiment, the overall length of the conductive stitching 16 run is adjusted to achieve the desired response. In another embodiment, the thickness T₁ of insulating jacket 12 of the conductive stitching 16 is selected to create a higher capacitive coupling (thinner jacket) or a lower capacitive coupling (thicker jacket). In another embodiment, the distance D, between stitches is adjusted to adjust the resonance-response. In another embodiment, the pattern of the stitches 16 is tailored to fine tune the resonance response. In another embodiment, the gauge of the stitches 16 is used to fine tune the resonance response. In yet another embodiment, the material type of the wire, such as copper, aluminum, silver, gold, platinum or the like, is used to fine tune the resonant performance.

The stitching, or lacing, of the conductive wire or thread in pre-determined gauges, patterns, and/or lengths within the molded conductive loaded resin-based antenna element plays an important role in tuning the antenna performance. A large electron pathway is established to interact with the molded conductive loaded resin-based network. Electronic conduction via insulated wire or thread is by capacitive coupling and/or inductive balancing with the micron conductive lattice matrix. The optimized pattern of conductive wire, or thread, segments of stitching on top and bottom of the conductive loaded resin-based molded element form a mesh of inductors and capacitors integrated into the network of conductive fiber and/or powder in the conductive loaded resin-based material. This combined network creates the susceptance, frequency response match location, and resonance bandwidth of the resulting antenna.

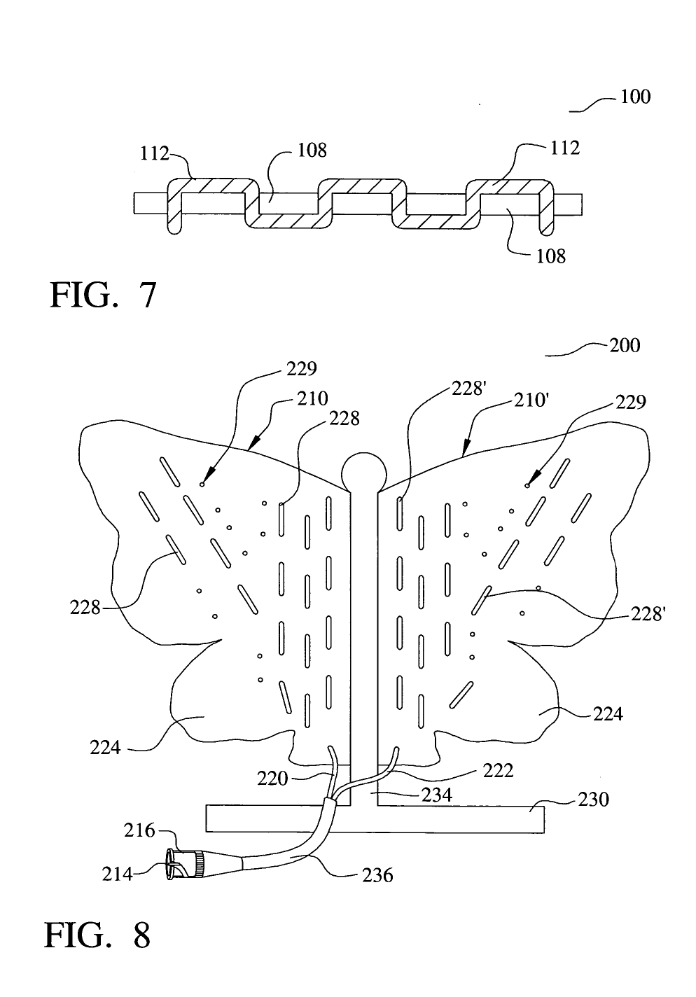

Referring now to FIG. 7, a second preferred embodiment of the present invention is illustrated. Another antenna element 100 is shown in cross section. As in the cross section of the antenna element 5 of FIG. 1a, a conductive stitching 112 is routed, or laced, into the conductive loaded resin-based material 108. Referring again to FIG. 7, the conductive stitching in this embodiment comprises a non-insulated wire 112. By using a non-insulated wire 112, a direct coupling between the signal wire 112 and micron conductive network of the conductive loaded resin-based material 108 is achieved. This approach reduces the parasitic capacitance in the signal coupling. It is found that resonant response of the antenna element 100 can be tuned for various polarizations by varying the length of the stitching run, the shape of the stitching pattern, and/or the length of each stitch. It is further found that the non-insulated conductive stitching 112 typically generates a wider resonance bandwidth than the insulated conductive stitching 16 shown in FIGS. 1a and 1b.

Referring now to FIG. 8, a third preferred embodiment of the present invention is illustrated. Another dipole antenna device 200 is shown. In this case, a unique appearing, butterfly antenna is formed. Again, the dipole antenna device 200 comprises two main element panels 210 and 210′ each comprising the conductive loaded resin-based material of the present invention. The signal element 210 is coupled to a first conductive wire 220 that is routed through a cable 236 and terminated in a connector pin 214. The counterpoise element 210′ is coupled to a second wire 222 that is also routed through the cable 236 and terminated in the connector ground ring 216. Other cable and/or pin configurations may be used. The first and second conductive wires 220 and 222 are then stitched into the conductive loaded resin-based material 224 of the panel element wings 210 and 210′. The stitching 228 and 228′ allows the signal wire 220 and the counterpoise wire 222 to be coupled, in distributed fashion, to the wing elements 210 and 210′. If the wires 220 and 222 are insulated, then the coupling is indirect. If the wires 220 and 222 are non-insulated, then the coupling is direct.

As an additional feature, unstitched holes 229, or perforations, in the antenna elements 210 and 210′ are found to further effect the electrical balancing within the conductive loaded resin-based material 224. Holes 229 may be added, but left unstitched, to fine adjust the resonance response. The holes 229 are found to interact with the surface area and the network of conductive fibers and/or powders.

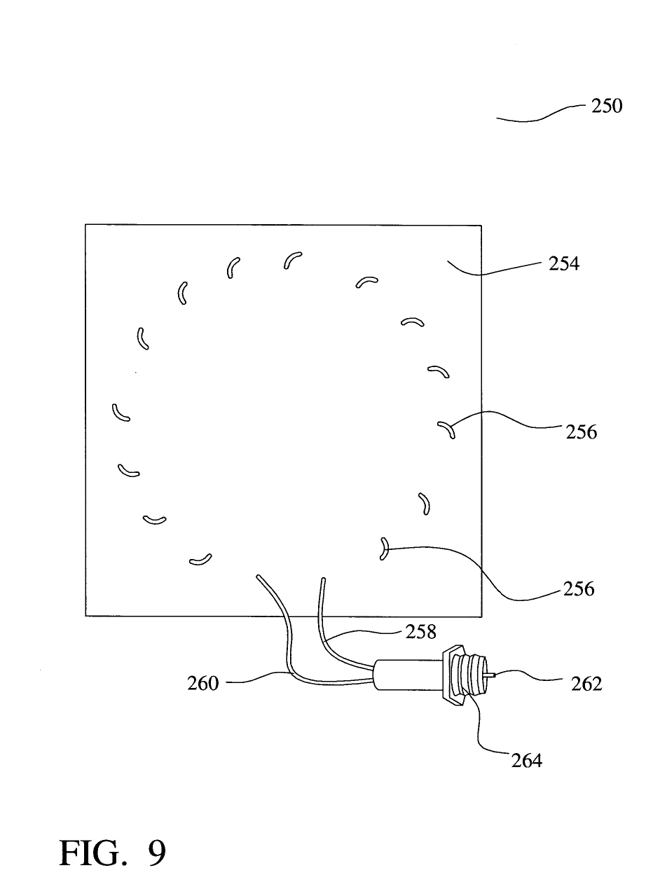

Referring now to FIG. 9, a fourth preferred embodiment of the present invention is illustrated. A monopole, patch antenna 250 comprising the conductive loaded resin-based material 254 is shown. In this case, a loop of conductive stitching 256 is formed into the conductive loaded resin-based panel 254. The ends of the conductive stitching loop project as connection wires 258 and 260 that are further coupled to connector terminals 264 and 262. In one embodiment, the conductive stitching comprises an insulated wire. In another embodiment, the conductive stitching comprises a non-insulated wire.

A wide variety of antenna structures are easily formed of the conductive loaded resin-based material and conductive stitching technique of the present invention. Monopole, dipole, geometric shapes, 2D, 3D, 4D, 5D, isotropic structures, planar, inverted F, PIFA, and the like, are all within the scope of the present invention.

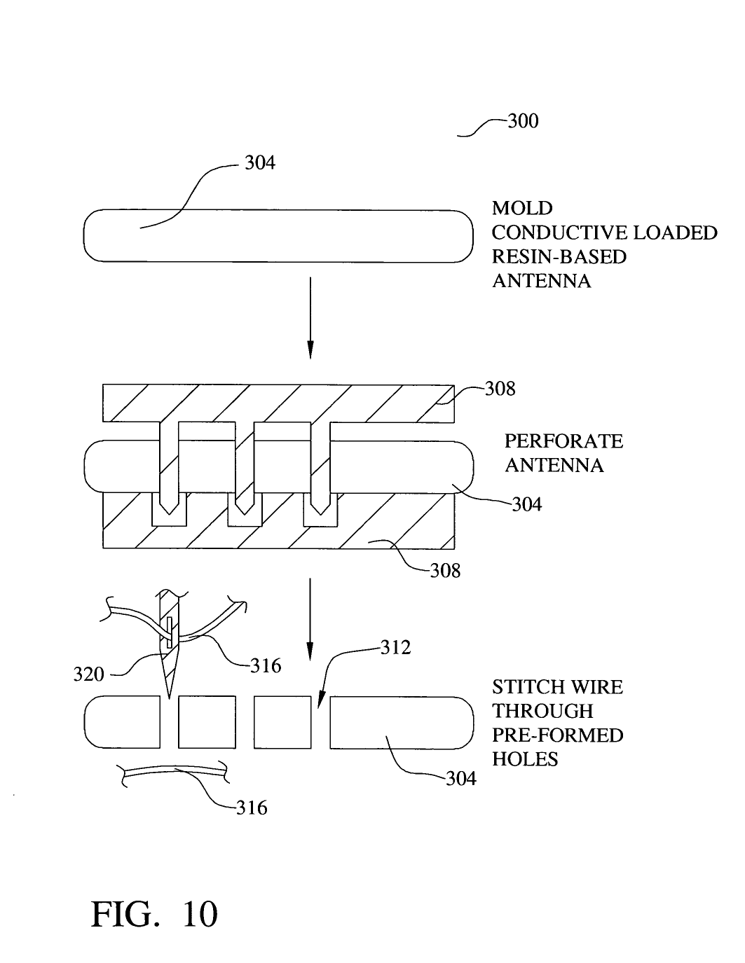

The novel antenna devices of the present invention are formed according to several different methods as disclosed herein. Referring now to FIG. 10, a fifth preferred embodiment of the present invention is illustrated. A method 300 to form a conductive loaded resin-based antenna device with conductive stitching is shown. In this method, the conductive loaded resin-based antenna element(s) 304 is first molded. Preferably, the molding operation creates the element structure 304, such as each wing of the butterfly antenna device of FIG. 8, with the structural features, such as perimeter, corresponding to the desired resonance properties. Subsequent to molding, the antenna element 304 is then perforated to form holes 312. In the illustrated embodiment, a punching apparatus 308, such as a press, is used to mechanically punch holes 312 through the antenna element 304. In an alternative embodiment, the hole punching apparatus 308 comprises both punch pins and shaping tooling to rough tune the shape of the antenna element from molded stock 304. In another embodiment, the punch pins are replaced with drill bits and the molded element 304 is simply drilled through with a pattern of stitching holes 312. Precision hole drilling using a conventional circuit board CNC apparatus, robotic apparatus, or the like, may be used. After forming the stitching holes, the antenna element 304 is stitched with a conductive stitching wire 316. In the illustrated embodiment, a mechanical sewing device 320, such as a sewing needle and/or sewing machine, is used for final stitching.

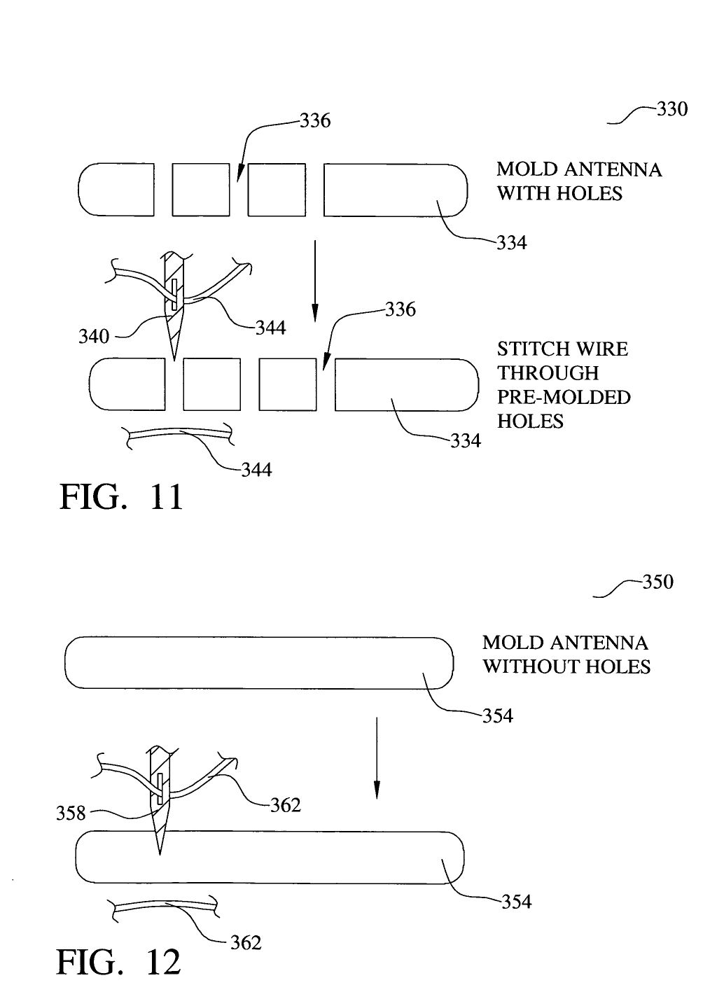

Referring now to FIG. 11, a sixth preferred embodiment of the present invention is illustrated. A method 330 to form a conductive loaded resin-based antenna device with conductive stitching is shown. In this method, the conductive loaded resin-based antenna element(s) 334 is first molded. Preferably, the molding operation creates the element structure 334, such as each wing of the butterfly antenna device of FIG. 8, with the structural features, such as perimeter, corresponding to the desired resonance properties. In addition to the perimeter, or shape, the holes 336 required for stitching are also molded into the antenna element 334. After molding, the antenna element 334 is stitched with a conductive stitching wire 344. In the illustrated embodiment, a mechanical sewing device 340, such as a sewing needle and/or sewing machine, is used for final stitching.

Referring now to FIG. 12, a seventh preferred embodiment of the present invention is illustrated. A method 350 to form a conductive loaded resin-based antenna device with conductive stitching is shown. In this method, the conductive loaded resin-based antenna element(s) 354 is first molded. Preferably, the molding operation creates the element structure 354, such as each wing of the butterfly antenna device of FIG. 8, with the structural features, such as perimeter, corresponding to the desired resonance properties. In this case, stitching holes are not molded into the antenna element nor punched into the antenna element post-molding. Rather, after molding, the antenna element 354 is stitched with a conductive stitching wire 362 with a mechanical sewing device 358, such as a sewing needle and/or sewing machine, capable of also creating the necessary perforations. This method 350 is particularly useful for conductive loaded resin-based material wherein the base resin remains flexible after molding.

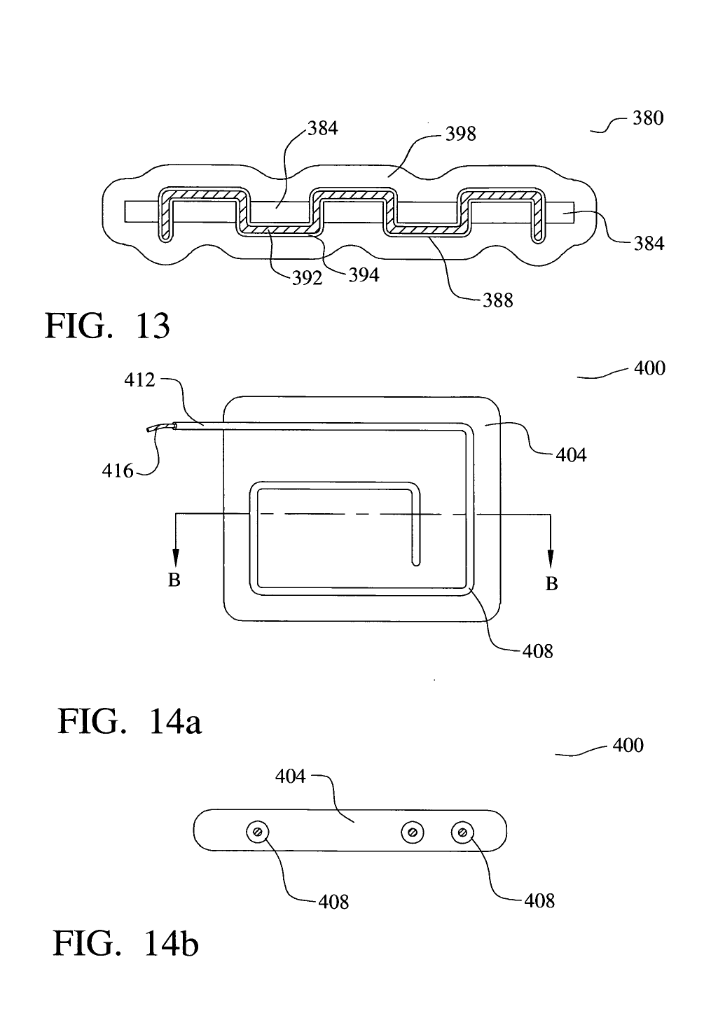

Referring now to FIG. 13, an eight preferred embodiment of the present invention is illustrated. An antenna device 380 comprising the conductive loaded resin-based material 384 and conductive stitching 388 is shown. In this case, a conformal layer 398 is formed over the antenna device 384 and 388 after stitching. The conformal layer 398 may comprise a heat shrink material, an environmental barrier, an over-molding, a PSA material, or the like. The conformal layer 398 creates a thin wall covering to protect the stitching, to provide environmental protection, or to provide a visually-attractive covering. The added layer 398 may also influence the performance of the antenna with the addition of dielectric properties that can, in turn, enhance the over-all Q and/or bandwidth of the antenna device 380. In the embodiment shown, the conformal layer 398 is applied after stitching of an insulated conductive wire, or thread, 392 and 394. In another embodiment, the conformal layer 398 is applied after stitching with a non-insulating wire or thread. In yet another embodiment, the conformal layer 398 comprises an over-molding of more conductive loaded resin-based material.

Referring now to FIGS. 14a and 14b, a ninth preferred embodiment of the present invention is illustrated. Another antenna device 400 is illustrated. In this embodiment, the conductive loaded resin-based element 404 is simply over-molded onto a conductive wire or thread 408. In the embodiment shown, the conductive wire 408 comprises a conductive core 416 and an insulating jacket 412. In this case, a capacitive coupling between the wire 408 and the conductive loaded resin-based element 404 is formed. In another embodiment, the conductive wire 408 is non-insulated such that a direct coupling is achieved.

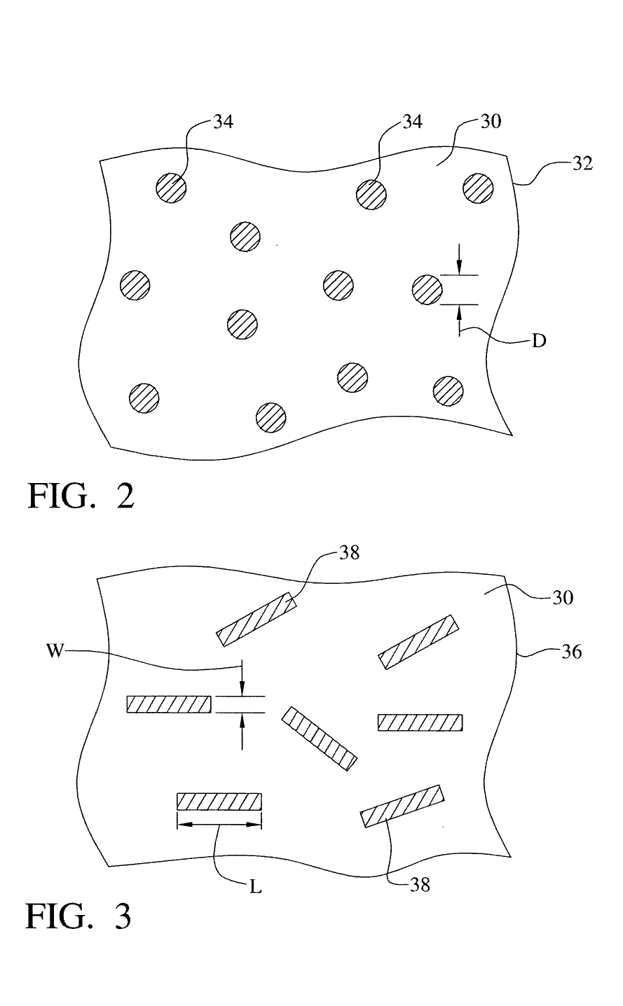

The conductive loaded resin-based material of the present invention typically comprises a micron powder(s) of conductor particles and/or in combination of micron fiber(s) homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

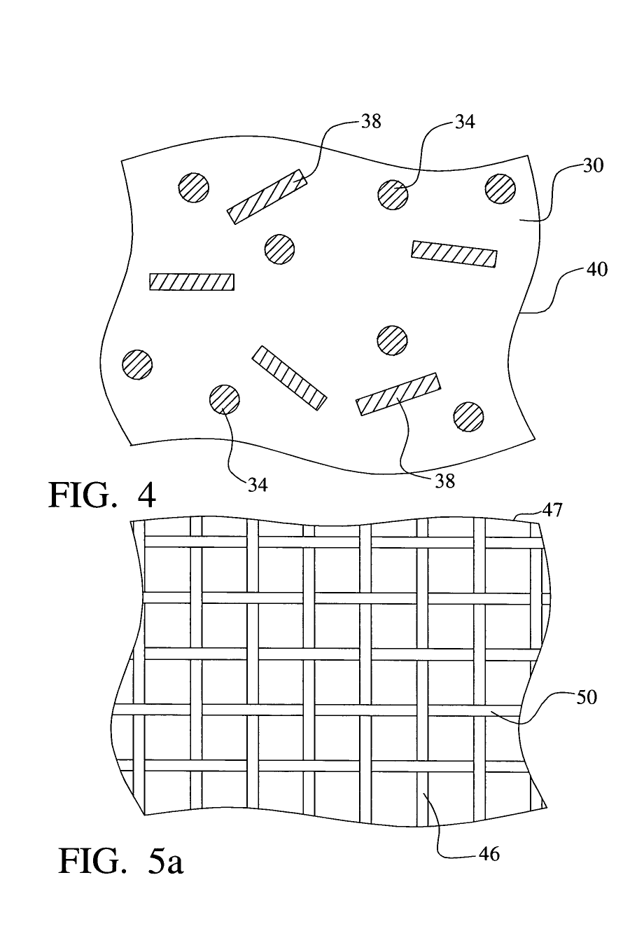

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The conductors used for these conductor particles 34 or conductor fibers 38 can be stainless steel, nickel, copper, silver, or other suitable metals or conductive fibers, or combinations thereof. These conductor particles and or fibers are homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 8-11 micron in diameter and lengths of 4-6 mm and comprising, by weight, about 30% of the total weight of the conductive loaded resin-based material will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 homogenized together within the resin base 30 during a molding process.

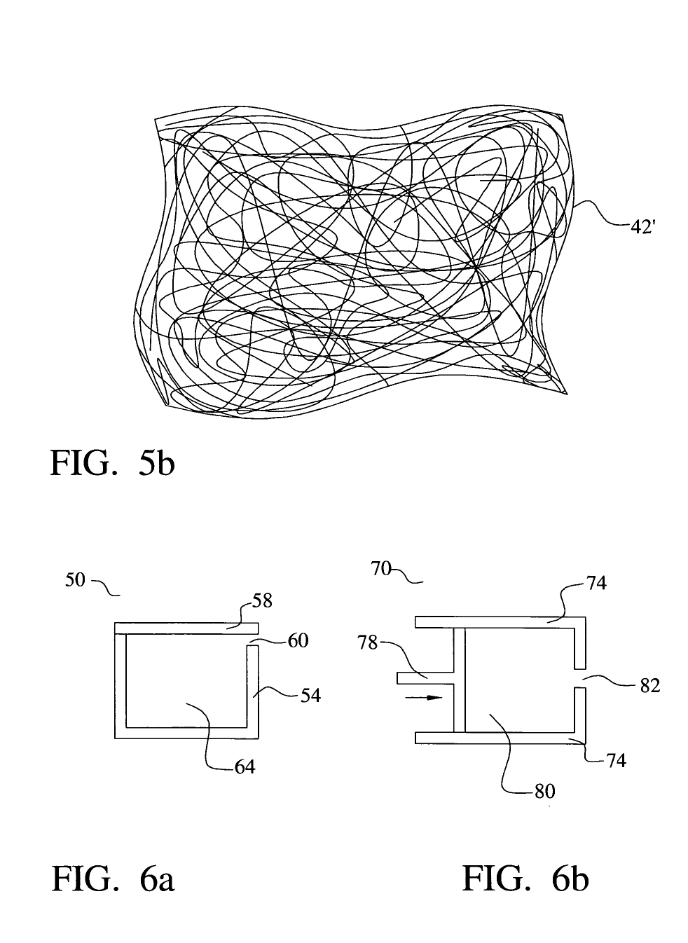

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Antenna devices formed from conductive loaded resin-based materials can be formed or molded in a number of different ways including injection molding, extrusion or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the homogenized conductive material cures by thermal reaction. The upper portion 58 and lower portion 54 of the mold are then separated or parted and the antenna elements are removed.

FIG. 6b shows a simplified schematic diagram of an extruder 70 for forming antenna devices using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. SUMMARIZE OBJECTS.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. An antenna device comprising:
an element of conductive loaded, resin-based material comprising conductive materials in a base resin host; and
a conductive wire embedded into said conductive loaded, resin-based material.

2. The device according to claim 1 wherein the percent by weight of said conductive materials is between about 20% and about 50% of the total weight of said conductive loaded resin-based material.

3. The device according to claim 1 wherein the percent by weight of said conductive materials is between about 20% and about 40% of the total weight of said conductive loaded resin-based material.

4. The device according to claim 1 wherein the percent by weight of said conductive materials is between about 25% and about 35% of the total weight of said conductive loaded resin-based material.

5. The device according to claim 1 wherein said conductive materials comprise metal powder.

6. The device according to claim 5 wherein said metal powder is nickel, copper, or silver.

7. The device according to claim 5 wherein said metal powder is a non-conductive material with a metal plating.

8. The device according to claim 7 wherein said metal plating is nickel, copper, silver, or alloys thereof.

9. The device according to claim 5 wherein said metal powder comprises a diameter of between about 3 μm and about 12 μm.

10. The device according to claim 1 wherein said conductive materials comprise non-metal powder.

11. The device according to claim 10 wherein said non-metal powder is carbon, graphite, or an amine-based material.

12. The device according to claim 1 wherein said conductive materials comprise a combination of metal powder and non-metal powder.

13. The device according to claim 1 wherein said conductive materials comprise micron conductive fiber.

14. The device according to claim 13 wherein said micron conductive fiber is nickel plated carbon fiber, or stainless steel fiber, or copper fiber, or silver fiber or combinations thereof.

15. The device according to claim 13 wherein said micron conductive fiber has a diameter of between about 3 μm and about 12 μm and a length of between about 2 mm and about 14 mm.

16. The device according to claim 13 wherein the percent by weight of said micron conductive fiber is between about 20% and about 40% of the total weight of said conductive loaded resin-based material.

17. The device according to claim 13 wherein said micron conductive fiber is stainless steel and wherein the percent by weight of said stainless steel fiber is between about 20% and about 40% of the total weight of said conductive loaded resin-based material.

18. The device according to claim 17 wherein said stainless steel fiber has a diameter of between about 3 μm and about 12 μm and a length of between about 2 mm and about 14 mm.

19. The device according to claim 1 wherein said conductive materials comprise a combination of conductive powder and conductive fiber.

20. The device according to claim 19 wherein said conductive fiber is stainless steel.

21. The device according to claim 1 wherein said base resin and said conductive materials comprise flame-retardant materials.

22. The device according to claim 1 wherein said conductive wire is stitched into said conductive loaded resin-based element.

23. The device according to claim 1 wherein said conductive wire is molded into said conductive loaded resin-based element.

24. The device according to claim 1 wherein said conductive wire comprises a center conductor and an insulating jacket.

25. The device according to claim 24 wherein said center conductor is copper, silver, gold, platinum, or aluminum.

26. The device according to claim 1 further comprising a second conductive loaded resin-based element wherein one said conductive loaded resin-based element is a counterpoise.

27. The device according to claim 1 further comprising a conformal layer overlying said conductive loaded resin-based element and said conductive wire.

28. The device according to claim 27 wherein said conformal layer is a heat shrink material.

29. The device according to claim 27 wherein said conformal layer is another said conductive loaded resin-based material.

30. An antenna device comprising:
an element of conductive loaded, resin-based material comprising conductive materials in a base resin host; and
a conductive wire embedded into said conductive loaded, resin-based material wherein said conductive wire is stitched into said conductive loaded resin-based material element.

31. The device according to claim 30 wherein the percent by weight of said conductive materials is between about 20% and about 40% of the total weight of said conductive loaded resin-based material.

32. The device according to claim 30 wherein the percent by weight of said conductive materials is between about 25% and about 35% of the total weight of said conductive loaded resin-based material.

33. The device according to claim 30 wherein said conductive materials comprise metal powder.

34. The device according to claim 33 wherein said metal powder is a non-conductive material with a metal plating.

35. The device according to claim 33 wherein said metal powder comprises a diameter of between about 3 μm and about 12 μm.

36. The device according to claim 30 wherein said conductive materials comprise non-metal powder.

37. The device according to claim 30 wherein said conductive materials comprise a combination of metal powder and non-metal powder.

38. The device according to claim 30 wherein said conductive materials comprise micron conductive fiber.

39. The device according to claim 38 wherein said micron conductive fiber has a diameter of between about 3 μm and about 12 μm and a length of between about 2 mm and about 14 mm.

40. The device according to claim 38 wherein the percent by weight of said micron conductive fiber is between about 20% and about 40% of the total weight of said conductive loaded resin-based material.

41. The device according to claim 38 wherein said micron conductive fiber is stainless steel and wherein the percent by weight of said stainless steel fiber is between about 20% and about 40% of the total weight of said conductive loaded resin-based material.

42. The device according to claim 41 wherein said stainless steel fiber has a diameter of between about 3 μm and about 12 μm and a length of between about 2 mm and about 14 mm.

43. The device according to claim 30 wherein said conductive materials comprise a combination of conductive powder and conductive fiber.

44. The device according to claim 43 wherein said conductive fiber is stainless steel.

45. The device according to claim 30 wherein said conductive wire comprises a center conductor and an insulating jacket.

46. The device according to claim 45 wherein said center conductor is copper, silver, gold, platinum, or aluminum.

47. The device according to claim 30 further comprising a second conductive loaded resin-based element wherein one said conductive loaded resin-based element is a counterpoise.

48. The device according to claim 30 further comprising a conformal layer overlying said conductive loaded resin-based element and said conductive wire.

49. The device according to claim 48 wherein said conformal layer is a heat shrink material.

50. The device according to claim 48 wherein said conformal layer is another said conductive loaded resin-based material.

51. A method to form an antenna device, said method comprising:
providing a conductive loaded, resin-based material comprising conductive materials in a resin-based host;
molding said conductive loaded, resin-based material into said antenna device; and
stitching a conductive wire into said antenna device.

52. The method according to claim 51 wherein the percent by weight of said conductive materials is between about 20% and about 40% of the total weight of said conductive loaded resin-based material.

53. The method according to claim 51 wherein said conductive materials comprise micron conductive fiber.

54. The method according to claim 53 wherein said micron conductive fiber is nickel plated carbon fiber, or stainless steel fiber, or copper fiber, or silver fiber or combinations thereof.

55. The method according to claim 53 wherein said micron conductive fiber has a diameter of between about 3 μm and about 12 μm and a length of between about 2 mm and about 14 mm.

56. The method according to claim 53 wherein the percent by weight of said micron conductive fiber is between about 20% and about 40% of the total weight of said conductive loaded resin-based material.

57. The method according to claim 53 wherein said micron conductive fiber is stainless steel and wherein the percent by weight of said stainless steel fiber is between about 20% and about 40% of the total weight of said conductive loaded resin-based material.

58. The method according to claim 57 wherein said stainless steel fiber has a diameter of between about 3 μm and about 12 μm and a length of between about 2 mm and about 14 mm.

59. The method according to claim 51 wherein said conductive materials comprise conductive powder.

60. The method according to claim 51 wherein said conductive materials comprise a combination of conductive powder and conductive fiber.

61. The method according to claim 51 wherein said molding comprises:
injecting said conductive loaded, resin-based material into a mold;
curing said conductive loaded, resin-based material; and
removing said antenna device from said mold.

62. The method according to claim 51 wherein said molding comprises:
loading said conductive loaded, resin-based material into a chamber;
extruding said conductive loaded, resin-based material out of said chamber through a shaping outlet; and
curing said conductive loaded, resin-based material to form said antenna device.

63. The method according to claim 51 further comprising subsequent mechanical processing of said molded conductive loaded, resin-based material.

64. The method according to claim 51 wherein said step of molding said conductive loaded, resin-based material into said antenna device produces perforations in said conductive loaded, resin-based material for said step of stitching.

65. The method according to claim 51 wherein said step of stitching produces perforations in said conductive loaded, resin-based material.

66. The method according to claim 51 wherein said step of stitching comprises routing said conductive wiring prior to said step of molding.

67. The method according to claim 51 wherein said conductive wire comprises a center conductor and an insulating jacket.

68. The method according to claim 67 wherein said center conductor is copper, silver, gold, platinum, or aluminum.

69. The method according to claim 51 further comprising forming a conformal layer overlying said antenna device.

70. The method according to claim 69 wherein said conformal layer is a heat shrink material.

71. The method according to claim 69 wherein said conformal layer is another said conductive loaded, resin-based material.
